(19) United States
(12) Patent Application Publication
(10) Pub. No.: US 2024/0332859 A1
(43) Pub. Date: Oct. 3, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takanori OSAWA, Osaka (JP); Keigo TAKAHASHI, Osaka (JP)

(21) Appl. No.: 18/610,637

(22) Filed: Mar. 20, 2024

(30) Foreign Application Priority Data
Mar. 30, 2023 (JP) 2023-055903

(51) Int. Cl. H01R 13/58

(52) U.S. Cl. CPC H01R 13/582

(57) ABSTRACT

A connector A is provided with a terminal module 30 including a communication cable 40 having a pair of signal wires 42 embedded in an insulating sheath 41, tip regions of the pair of signal wires 42 extending as wire exposed portions 43 from a tip surface 41S of the sheath 41, and a dielectric 31 for accommodating a pair of signal terminal fittings 33 individually fixed to a pair of the wire exposed portions 43, the wire exposed portions 43 being drawn out from signal wire draw-out openings 35 of the dielectric 31, and a housing 10 for accommodating a tip region of the communication cable 40 and the dielectric 31. A routing groove 20 for accommodating the pair of wire exposed portions 43 is formed in the housing 10.

### CROSS-REFERENCE TO RELATED APPLICATIONS

This application is based on and claims priority from Japanese Patent Application No. 2023-055903, filed on Mar. 30, 2023, with the Japan Patent Office, the disclosure of which is incorporated herein in its entirety by reference.

### TECHNICAL FIELD

The present disclosure relates to a connector.

### BACKGROUND

In differential signal transmission, a twisted pair cable formed by twisting two wires is used as a communication line. Japanese Patent Laid-open Publication No. 2016-162588 discloses a connector provided with a twisted pair cable, terminal portions connected to end parts of a pair of wires constituting the twisted pair cable and a connector body for accommodating a pair of the terminal portions. In an end part of the twisted pair cable, the wires are untwisted to crimp the terminal portions. The terminal portions are inserted into the connector body from behind. At this time, there is a concern that the terminal portions are improperly inserted with an operation method of simultaneously inserting the pair of terminal portions. Thus, after one terminal portion is inserted into the connector body, the other terminal portion is preferably inserted into the connector body after being temporarily moved rearward of the connector body.

### SUMMARY

To separately insert the pair of terminal portions, the wires need to be untwisted over a length corresponding at least to the entire lengths of the terminal portions. However, if the wires are untwisted, an interval between the wires is easily widened. If the interval of the wires is widened, transmission characteristics are degraded.

A connector of the present disclosure was completed on the basis of the above situation and aims to suppress the degradation of transmission characteristics.

The present disclosure is directed to a connector with a terminal module including a communication cable having a pair of signal wires embedded in an insulating sheath, tip regions of the pair of signal wires extending as wire exposed portions from a tip surface of the sheath, and a terminal holding member for accommodating a pair of terminal fittings individually fixed to a pair of the wire exposed portions, the wire exposed portions being drawn out from wire draw-out openings of the terminal holding member, and a housing for accommodating a tip region of the communication cable and the terminal holding member accommodating the pair of terminal fittings, a routing groove for accommodating the pair of wire exposed portions being formed in the housing.

According to the present disclosure, the degradation of transmission characteristics can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector of a first embodiment.

FIG. 2 is an exploded perspective view of the connector shown in FIG. 1.

FIG. 3 is a perspective view showing a state where a terminal module, a one-piece rubber plug and a rubber plug holding member are mounted in a housing body in the connector of the first embodiment.

FIG. 4 is a back view of the housing body shown in FIG. 1.

FIG. 5 is a back view in section showing a state where a communication cable is routed in a routing space in the connector of the first embodiment.

FIG. 6 is a back view in section showing a state while the communication cable is being routed in the routing space in the connector of the first embodiment.

FIG. 7 is a side view in section of the connector shown in FIG. 1.

FIG. 8 is a side view in section showing a state while the communication cable is being routed in the routing space in the connector of the first embodiment.

FIG. 9 is a perspective view of a connector of a second embodiment.

FIG. 10 is an exploded perspective view of the connector shown in FIG. 9.

FIG. 11 is a perspective view showing a state where a terminal module, a one-piece rubber plug and a rubber plug holding member are mounted in a housing body in the connector of the second embodiment.

FIG. 12 is a back view of the housing body shown in FIG. 9.

FIG. 13 is a back view showing a state where a communication cable is routed in a routing space in the connector of the second embodiment.

FIG. 14 is a back view showing a state while the communication cable is being routed in the routing space in the connector of the second embodiment.

FIG. 15 is a side view in section showing the state where the communication cable is routed in the routing space in the connector of the second embodiment.

FIG. 16 is a side view in section showing a state while the communication cable is being routed in the routing space in the connector of the second embodiment.

FIG. 17 is a perspective view of a terminal holding member shown in FIG. 10.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure are listed and described. Arbitrary combinations of a plurality of embodiments described below without contradicting each other are also included in embodiments of the invention.

(1) The connector of the present disclosure is provided with a terminal module including a communication cable having a pair of signal wires embedded in an insulating sheath, tip regions of the pair of signal wires extending as wire exposed portions from a tip surface of the sheath, and a terminal holding member for accommodating a pair of terminal fittings individually fixed to a pair of the wire exposed portions, the wire exposed portions being drawn out from wire draw-out openings of the terminal holding member, and a housing for accommodating a tip region of the communication cable and the terminal holding member accommodating the pair of terminal fittings, a routing groove for accommodating the pair of wire exposed portions being formed in the housing. According to the configuration of the present disclosure, the separation of the signal wires in the wire exposed portions from each other can be suppressed by accommodating the pair of signal wires into the routing groove. Therefore, it is possible to suppress the degradation of transmission characteristics due to an enlarged interval between the signal wires in the wire exposed portions.

(2) Preferably, the routing groove is shaped to be open rearwardly of the housing, the wire draw-out openings are arranged in a widthwise central part of the housing and the routing groove is arranged at a position shifted in the width direction from a widthwise center of the housing in a back view of the housing, and a guiding portion for guiding the wire exposed portions toward the routing groove when the wire exposed portions are pressed from behind is formed at a position adjacent to the routing groove on the side of the widthwise center. According to this configuration, even if the positions of the wire exposed portions are shifted more toward the widthwise center than the routing groove when the communication cable is accommodated into the housing, the wire exposed portions can be guided into the routing groove by the guiding portion.

(3) Preferably in (2), the housing is formed with an accommodation recess for accommodating a tip part of the sheath in a positioned state in the back view, the guiding portion is arranged on a virtual straight line connecting a position of the tip surface of the sheath where the signal wire extends and the wire draw-out opening in the back view with the sheath positioned by the accommodation recess, and the accommodation recess is arranged forward of the guiding portion. According to this configuration, even if the signal wires are shifted in position from the routing groove, the wire exposed portions are pressed against the guiding portion by moving the tip part of the sheath toward the accommodation recess. Therefore, an operation of accommodating the tip part of the sheath into the accommodation recess and an operation of guiding the wire exposed portions overlapping the guiding portion into the routing groove can be performed in one action.

(4) Preferably in (1), the routing groove is shaped to be open rearwardly of the housing, the terminal holding member is formed with an eaves portion having a cantilever shape, the eaves portion covering parts of routing paths for the wire exposed portions from behind, and a rear surface of the eaves portion is formed with a guiding surface for causing the wire exposed portions to slide toward a projecting end of the eaves portion when being pushed from behind by the wire exposed portions. According to this configuration, even if the wire exposed portions overlap the rear surface of the eaves portion when the communication cable is accommodated into the housing, the wire exposed portions can be guided to the routing paths for the wire exposed portions by the guiding surface, wherefore the wire exposed portions can be accommodated into the routing groove.

(5) Preferably in (4), the housing is formed with an accommodation recess for accommodating a tip part of the sheath, and the routing groove and a pair of the wire draw-out openings are arranged side by side along an axis of the tip part of the sheath accommodated in the accommodation recess in a back view of the housing. According to this configuration, the pair of wire exposed portions can be routed in shortest paths connecting the wire draw-out openings and the tip surface of the sheath. Further, a routing space in the width direction for the pair of wire exposed portions can be suppressed to be small.

(6) Preferably in (5), another wire different from the signal wires is drawn out from the terminal holding member and, when a direction orthogonal to the axis of the tip part of the sheath accommodated in the accommodation recess in the back view is defined as a width direction, the wire draw-out openings for the signal wires and another wire draw-out opening for the other wire are arranged side by side in the width direction, and the accommodation recess and the routing groove are arranged at positions deviated in the width direction from a widthwise center of the housing. According to this configuration, the signal wires and the other wire can be routed along the paths separated in the width direction orthogonal to the axis of the sheath. In this way, it is possible to suppress the degradation of transmission characteristics due to the approach of the other wire and the signal wires.

### Details of Embodiments of Present Disclosure

### First Embodiment

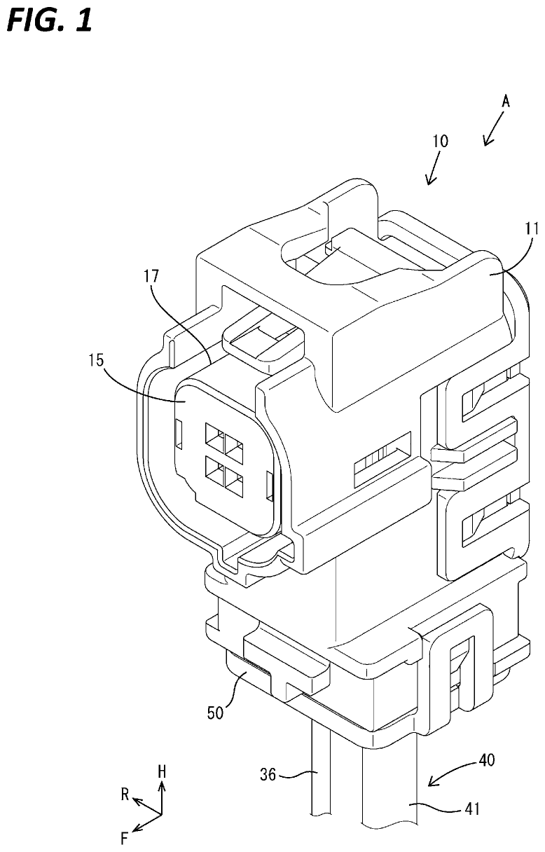

A connector A of a first specific embodiment of the present disclosure is described with reference to FIGS. 1 to 8. The present invention is not limited to these illustrations, but is represented by claims and intended to include all changes in the scope of claims and in the meaning and scope of equivalents. In the first embodiment, a direction F in FIGS. 1 to 3, 7 and 8 is defined as a forward direction concerning a front-rear direction. A direction H in FIGS. 1 to 8 is defined as an upward direction concerning a vertical direction. A direction R in FIGS. 1 to 5 is defined as a rightward direction concerning a lateral direction. The lateral direction and a width direction are used as synonyms.

The connector A of the first embodiment is provided with a housing 10 and a terminal module 30. In a side view of the connector A, the connector A has a vertically long block shape as a whole.

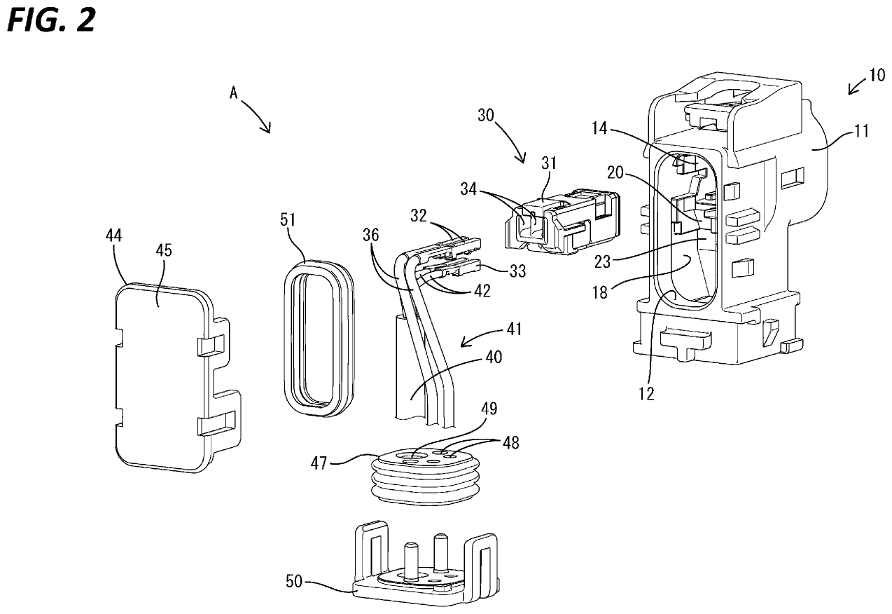

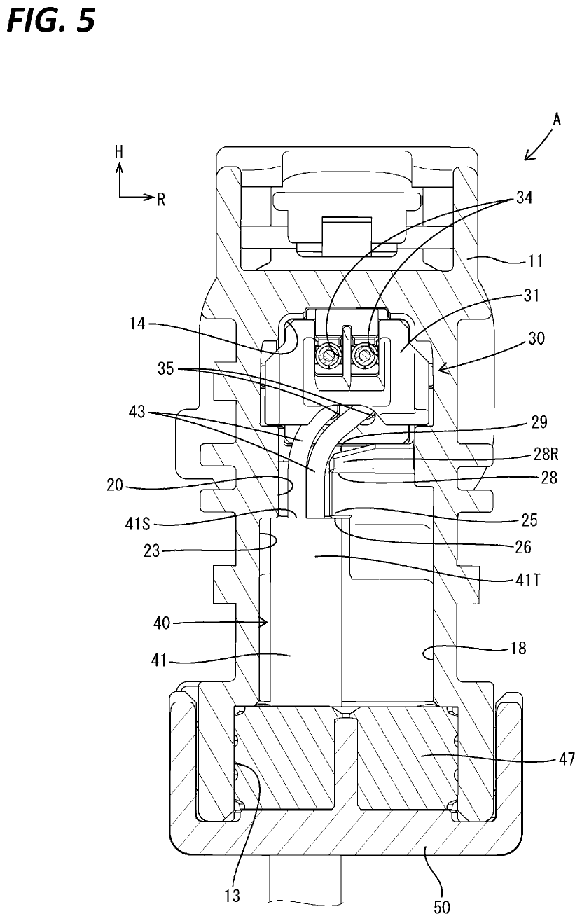

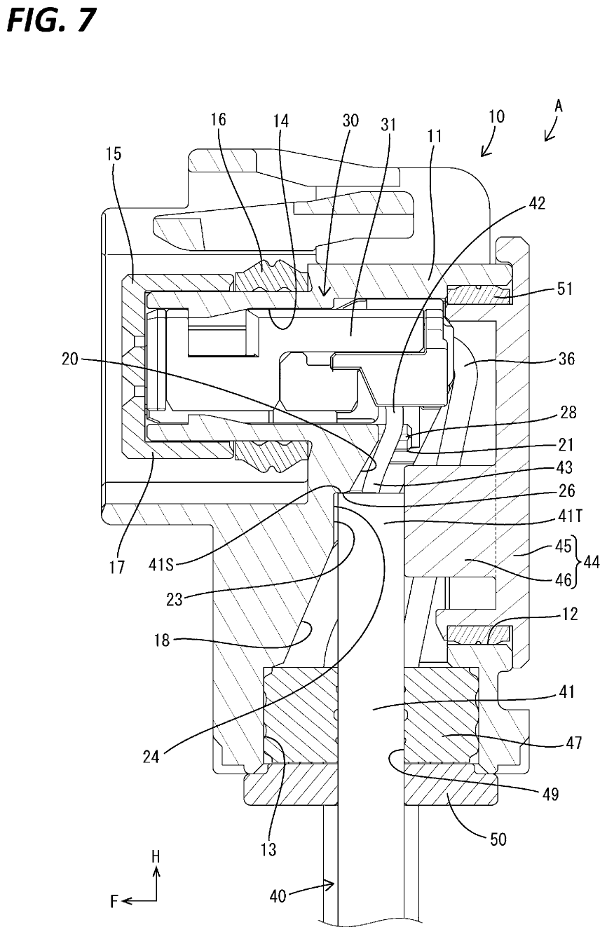

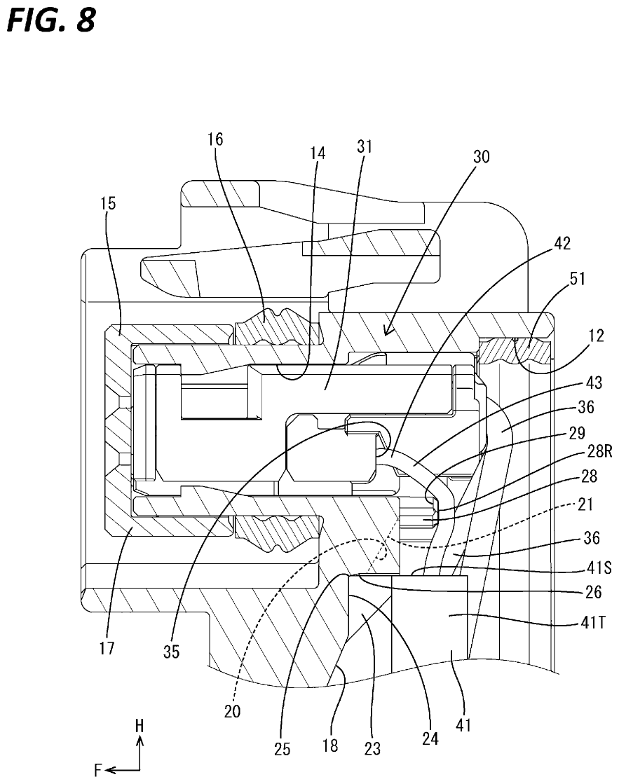

As shown in FIG. 2, the housing 10 is configured by assembling a housing body 11, a cover 44, a rear sealing member 51, a one-piece rubber plug 47 and a rubber plug holding member 50. The housing body 11 is a box-shaped member including an opening 12 in a rear surface. As shown in FIGS. 5 and 7, a lower wall part of the housing body 11 is formed with a routing hole 13 vertically penetrating through the lower wall part. As shown in FIGS. 5 to 8, an upper end part of the housing body 11 is formed with a module accommodation chamber 14. The front end of the module accommodation chamber 14 is open in the front surface of the housing body 11. The rear end of the module accommodation chamber 14 is open rearward in the housing body 11. As shown in FIGS. 7 and 8, a fitting portion 17 to be fit to a mating connector (not shown) is formed by mounting a front member 15 and a front sealing member 16 on an upper end part of the front surface of the housing body 11.

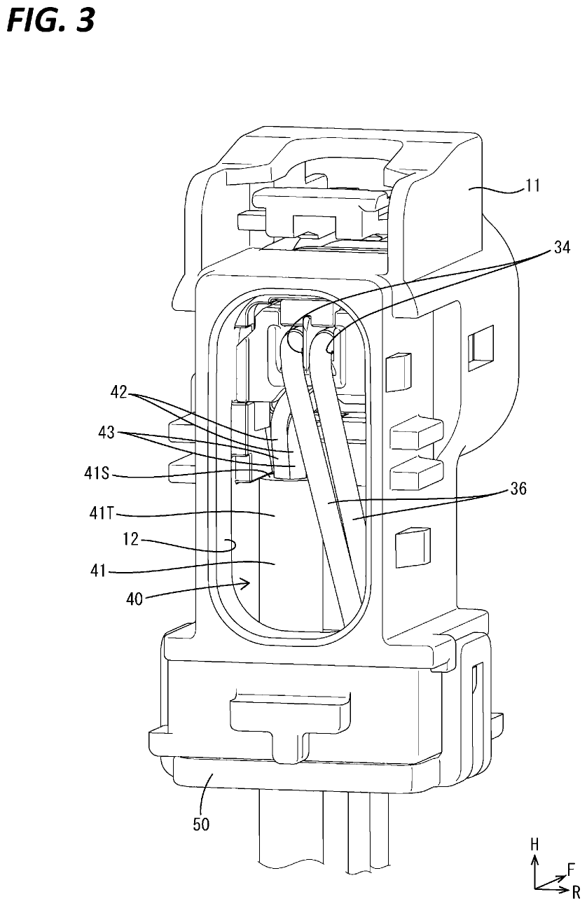

A routing space 18 communicating with the rear end of the module accommodation chamber 14 is formed inside the housing body 11. The routing space 18 is composed of a region behind the module accommodation chamber 14 and a region below the module accommodation chamber 14, out of the housing body 11. As shown in FIGS. 3, 7 and 8, a pair of power wires 36 and one communication cable 40 are routed in the vertical direction in the routing space 18. A routing groove 20, an accommodation recess 23 and a guiding portion 28 are formed in an upper end part of the routing space 18.

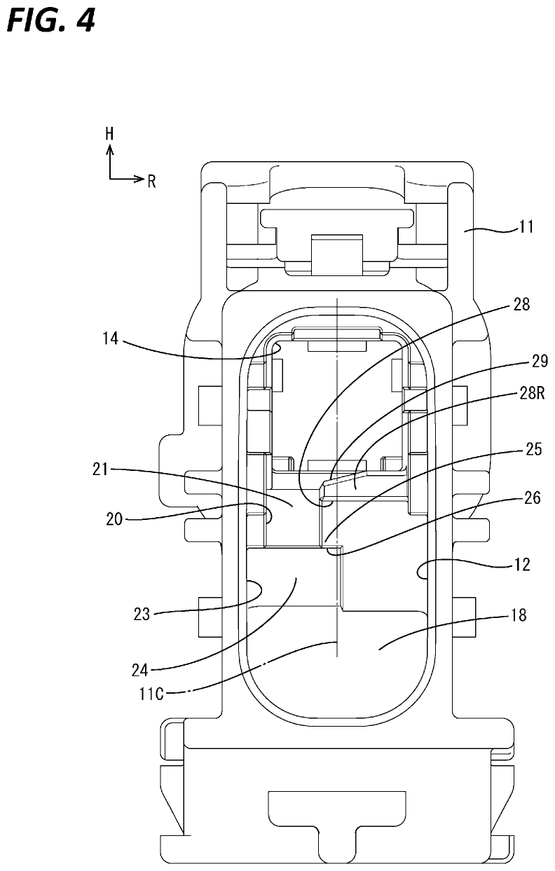

As shown in FIGS. 4 to 6, in a back view of the housing body 11, the upper end of the routing groove 20 is located slightly below the module accommodation chamber 14. As shown in FIG. 4, the routing groove 20 is arranged at a position deviated leftward in the width direction from a widthwise center 11C of the housing body 11. As shown in FIG. 7, the routing groove 20 is a recess open both upward and downward and rearward. A groove bottom surface 21 (front surface) of the routing groove 20 is inclined in an overhanging manner such that a lower end is located forward of an upper end.

The accommodation recess 23 is a recess open downward and rearward. As shown in FIGS. 4 to 6, the accommodation recess 23 is arranged at a position deviated leftward in the width direction from the widthwise center 11C of the housing body 11, similarly to the routing groove 20. The routing groove 20 and the accommodation recess 23 are arranged adjacent in the vertical direction. The upper end of the accommodation recess 23 communicates with the lower end of the routing groove 20. In the back view, a width of the accommodation recess 23 is larger than that of the routing groove 20. As shown in FIGS. 7 and 8, a back surface 24 (front surface) of the accommodation recess 23 is located forward of the groove bottom surface 21 of the routing groove 20. A boundary between a lower end part of the accommodation recess 23 and that of the routing groove 20 constitutes a step portion 25. A part of the step portion 25 facing the inside of the accommodation recess 23 functions as a stopper 26.

As shown in FIGS. 4 to 6, the guiding portion 28 is arranged to the right of an upper end part of the routing groove 20 in the back view. The guiding portion 28 is shaped to project rearward. A rear surface 28R (projecting end surface) of the guiding portion 28 is located rearward of the groove bottom surface 21 of the routing groove 20 and the back surface 24 of the accommodation recess 23. The guiding portion 28 functions as a path restricting portion for routing wire exposed portions 43 of signal wires 42 to be described later along paths bent in the back view. An upper edge part of the guiding portion 28 is formed with a guiding edge part 29 inclined to be gradually lower toward the routing groove 20 in the back view.

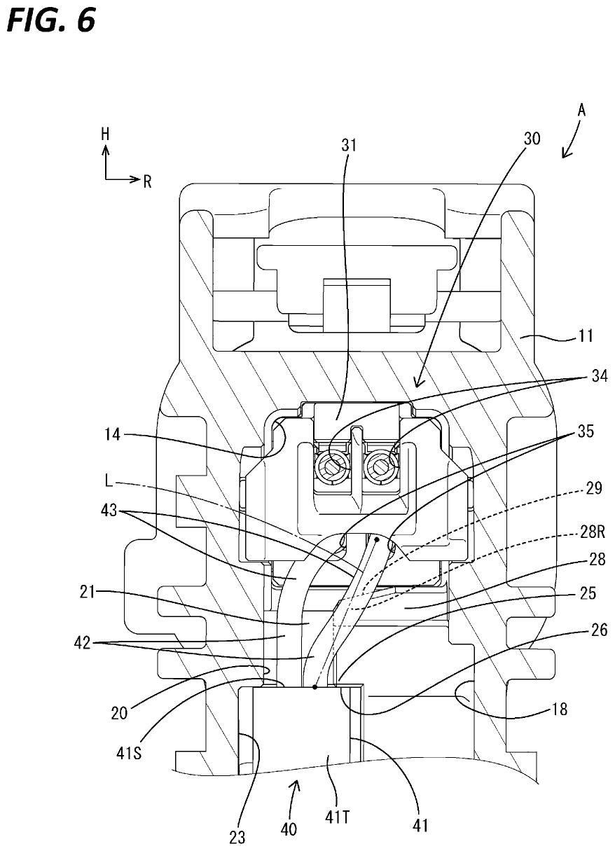

As shown in FIG. 2, the terminal module 30 includes a dielectric 31, a pair of power supply terminal fittings 32, a pair of signal terminal fittings 33, a pair of power wires 36 and one communication cable 40. The dielectric 31 is, for example, configured by assembling a plurality of components. The pair of power supply terminal fittings 32 and the pair of signal terminal fittings 33 are accommodated in the dielectric 31. As shown in FIGS. 5 and 6, a pair of power supply wire draw-out openings 34 arranged at an interval in the width direction and a pair of signal wire draw-out openings 35 arranged at an interval in the width direction are formed in the rear surface of the dielectric 31. The pair of power supply wire draw-out openings 34 are open in an upper region of the rear surface of the dielectric 31. The pair of signal wire draw-out openings 35 are open in a lower region of the rear surface of the dielectric 31. The terminal module 30 is inserted into the module accommodation chamber 14 from behind the housing body 11.

The pair of power wires 36 are constituted by coated wires. The power supply terminal fitting 32 is fixed to a tip part of each power wire 36. The power wire 36 is drawn out rearward from the power supply wire draw-out opening 34 of the dielectric 31. The pair of power wires 36 drawn out from the power supply wire draw-out openings 34 are routed in the vertical direction in a right half region of the routing space 18.

The communication cable 40 is an electrically conductive path for differential communication and includes a sheath 41 having a circular cross-section and a pair of signal wires 42 embedded in the sheath 41. The signal wire 42 is constituted by a coated wire. In the sheath 41, the pair of signal wires 42 are twisted to form a twisted pair cable (not shown). In a tip region of the communication cable 40, the sheath 41 is removed to expose tip regions of the pair of signal wires 42. A part of the signal wire 42 projecting from a tip surface 41S of the sheath 41 and untwisted is defined as the wire exposed portion 43. The signal terminal fitting 33 is fixed to a tip part of each wire exposed portion 43. The wire exposed portion 43 is drawn out rearward from the signal wire draw-out opening 35 of the dielectric 31.

The communication cable 40 is routed in the vertical direction in a left half region of the routing space 18. A tip part 41T of the sheath 41 is accommodated in the accommodation recess 23 with the tip surface 41S facing upward. The tip surface 41S of the sheath 41 is located to come into contact with or closely face the stopper 26 from below. The tip part 41T of the sheath 41 is accommodated in the accommodation recess 23 while being positioned by the stopper 26. Further, the sheath 41 is positioned with respect to the housing 10 by the accommodation recess 23. A pair of the wire exposed portions 43 (signal wires 42) drawn out from the signal wire draw-out openings 35 are accommodated in the routing groove 20. In the routing groove 20, the pair of wire exposed portions 43 are laterally arranged in parallel and in proximity to each other with axes oriented in the vertical direction. Out of the pair of wire exposed portions 43, parts between the signal wire draw-out openings 35 and the upper end of the routing groove 20 are routed in a direction oblique to both the vertical direction and width direction in the back view.

The cover 44 is mounted on the housing body 11 to close the opening 12. As shown in FIG. 7, the cover 44 includes a plate-like body portion 45 and a separation restricting portion 46 projecting from the front surface of the plate-like body portion 45. With the cover 44 mounted on the housing body 11, the separation restricting portion 46 is arranged to overlap the accommodation recess 23 in the back view. The one-piece rubber plug 47 is mounted into the routing hole 13 of the housing body 11 in a liquid-tight manner. As shown in FIG. 2, the one-piece rubber plug 47 is formed with a pair of first sealing holes 48 and one second sealing hole 49 penetrating in the vertical direction. The pair of power wires 36 are inserted through the pair of first sealing holes 48 in a liquid-tight manner. The communication cable 40 is inserted through the second sealing hole 49 in a liquid-tight manner. The rubber plug holding member 50 is mounted on a lower end part of the housing body 11. The rubber plug holding member 50 is a member for preventing the one-piece rubber plug 47 from coming out downward from the routing hole 13.

An assembly procedure of the connector A is described. With the sheath 41 of the communication cable 40 and the power wires 36 inserted through the one-piece rubber plug 47, the signal terminal fittings 33 are crimped to the wire exposed portions 43 of the signal wires 42 and the power supply terminal fittings 32 are fixed to the power wires 36. Subsequently, the signal terminal fittings 33 and the power supply terminal fittings 32 are accommodated into the dielectric 31, thereby assembling the terminal module 30. Thereafter, the assembled terminal module 30 is passed through the routing hole 13 from below the housing body 11, passed through the routing space 18 and temporarily pulled out rearward to the outside of the housing body 11 through the opening 12. Thereafter, the dielectric 31 is inserted into the module accommodation chamber 14 from behind.

Thereafter, the two power wires 36 are accommodated into the right region in the routing space 18 and routed in the vertical direction. The communication cable 40 is accommodated into the left region in the routing space 18 and routed in the vertical direction. In routing the communication cable 40, the tip part 41T of the sheath 41 of the communication cable 40 is accommodated into the accommodation recess 23 while being moved forward.

In the back view, the accommodation recess 23 is arranged at a position separated obliquely to a left lower side from the signal wire draw-out openings 35 arranged in widthwise central part of the housing body 11. With the tip part 41T of the sheath 41 accommodated in the accommodation recess 23, the guiding portion 28 is present to cross in the lateral direction a virtual straight line L connecting a position of the tip surface 41S of the sheath 41 where the right wire exposed portion 43 extends and a center of the right signal wire draw-out opening 35 as shown in FIG. 6. Thus, there is a concern that the right wire exposed portion 43 rides on the rear surface 28R of the guiding portion 28 and cannot be accommodated into the routing groove 20 as shown in FIG. 8 when an attempt is made to push the tip part 41T (upper end part) of the sheath 41 into the accommodation recess 23.

Here, an upper edge part of the guiding portion 28 is formed with the guiding edge part 29 for guiding the wire exposed portions 43 into the routing groove 20. If the tip part 41T of the sheath 41 is moved forward from right behind the accommodation recess 23, the right wire exposed portion 43 moves leftward toward the routing groove 20 while sliding in contact with the guiding edge part 29, passes over the left end of the guiding edge part 29 and is accommodated into the routing groove 20. The left wire exposed portion 43 is also accommodated into the routing groove 20 by being pushed by the right wire exposed portion 43. Therefore, even if a worker does not touch the wire exposed portions 43 (signal wires 42), the two wire exposed portions 43 can be routed along predetermined paths by a one-action operation of accommodating the sheath 41 into the accommodation recess 23.

At the same time as the two wire exposed portions 43 are accommodated into the routing groove 20, parts thereof above the routing groove 20 are routed obliquely to both the vertical direction and width direction between the upper end of the routing groove 20 and the signal wire draw-out openings 35. In the routing groove 20, the pair of wire exposed portions 43 are arranged side by side in the width direction. The routing groove 20 has a pair of left and right inner wall surfaces. An interval between the inner wall surfaces (width of the routing groove 20) is slightly larger than twice the outer diameter of the two wire exposed portions 43 (signal wires 42). Therefore, the two wire exposed portions 43 are not largely separated in the width direction. Further, the two wire exposed portions 43 are routed between the tip surface 41S of the sheath 41 and the signal wire draw-out openings 35 while hardly having an extra length. Therefore, the two wire exposed portions 43 are not largely separated in the width direction also between the routing groove 20 and the wire draw-out openings.

After the power wires 36 and the communication cable 40 are routed in the routing space 18, the one-piece rubber plug 47 is moved upward and mounted into the routing hole 13 with the power wires 36 and the communication cable 40 held not to move upward with respect to the housing body 11. Thereafter, the rubber plug holding member 50 is mounted on the lower end part of the housing body 11. Even if the communication cable 40 is pushed upward when the one-piece rubber plug 47 is moved upward, the communication cable 40 does not move upward in the routing space 18 since the tip surface 41S of the sheath 41 butts against the stopper 26.

Thereafter, the cover 44 having the rear sealing member 51 mounted therein is mounted on a rear surface part of the housing body 11. In this way, the opening 12 in the rear surface of the housing body 11 is closed in a liquid-tight manner by the plate-like body portion 45 of the cover 44 and the rear sealing member 51. In the above way, the assembly of the connector A is completed.

With the cover 44 mounted on the housing body 11, the separation restricting portion 46 of the cover 44 is in contact with or closely facing the tip part 41T of the sheath 41 from behind as shown in FIG. 7. In this way, a rearward movement of the communication cable 40 is restricted, wherefore the sheath 41 is held accommodated in the accommodation recess 23 and the wire exposed portions 43 are held accommodated in the routing groove 20.

The connector A of the first embodiment is provided with the terminal module 30 and the housing 10. The terminal module 30 includes the communication cable 40, the dielectric 31 and the pair of signal terminal fittings 33. The communication cable 40 is configured such that the pair of signal wires 42 are embedded in the insulating sheath 41. The sheath 41 is removed in the tip part of the communication cable 40. The tip regions of the pair of signal wires 42 extend as the wire exposed portions 43 from the tip surface 41S of the sheath 41. The pair of wire exposed portions 43 are individually fixed to the pair of signal terminal fittings 33. The pair of signal terminal fittings 33 are accommodated in the dielectric 31. The pair of wire exposed portions 43 are individually drawn out rearward from the pair of signal wire draw-out openings 35 open in the rear surface of the dielectric 31. The dielectric 31 accommodating the tip region of the communication cable 40 and the pair of signal terminal fittings 33 is accommodated in the housing 10. The routing groove 20 for accommodating the pair of wire exposed portions 43 is formed in the housing 10. The separation of the wire exposed portions 43 (signal wires 42) from each other can be suppressed by accommodating the pair of wire exposed portions 43 into the routing groove 20. According to the connector A of the first embodiment, it is possible to suppress the degradation of communication characteristics due to the enlarged interval between the wire exposed portions 43.

The routing groove 20 is shaped to be open rearwardly of the housing body 11 constituting the housing 10. In the back view of the housing 10, the signal wire draw-out openings 35 are arranged in the widthwise central part of the housing body 11. The routing groove 20 is arranged at the position shifted leftward in the width direction from the widthwise center 11C of the housing body 11 (housing 10). The guiding portion 28 for guiding the wire exposed portions 43 toward the routing groove 20 when the wire exposed portions 43 are pushed from behind is formed at the position adjacent to the routing groove 20 on the side of the widthwise center 11C. According to this configuration, even if the positions of the wire exposed portions 43 are shifted more toward the widthwise center 11C than the routing groove 20 when the communication cable 40 is accommodated into the housing 10, the wire exposed portions 43 can be guided into the routing groove 20 by the guiding portion 28.

The housing 10 is formed with the accommodation recess 23 for accommodating the tip part 41T of the sheath 41 positioned in the width direction in the back view. With the tip part 41T of the sheath 41 positioned by the accommodation recess 23, the guiding portion 28 is arranged on the virtual straight line L connecting the position of the tip surface 41S of the sheath 41 where the wire exposed portion 43 (signal wire 42) extends and the signal wire draw-out opening 35 in the back view. The accommodation recess 23 is arranged forward of the guiding portion 28. According to this configuration, even if the signal wires 42 (wire exposed portions 43) are shifted rightward (toward the widthwise center 11C) from the routing groove 20, the wire exposed portions 43 are pressed against the guiding portion 28 by moving the tip part 41T of the sheath 41 toward the accommodation recess 23. Therefore, an operation of accommodating the tip part 41T of the sheath 41 into the accommodation recess 23 and an operation of guiding the wire exposed portion 43 overlapping the guiding portion 28 into the routing groove 20 can be performed in one action.

### Second Embodiment

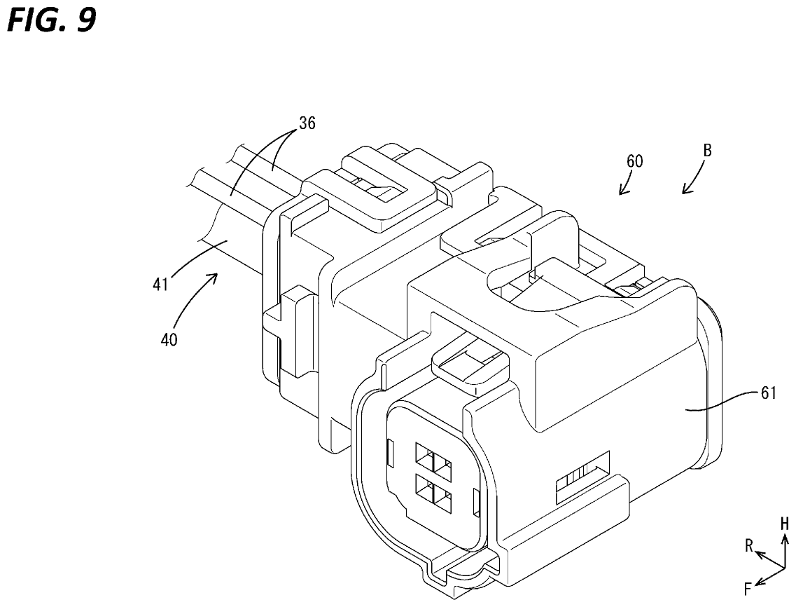

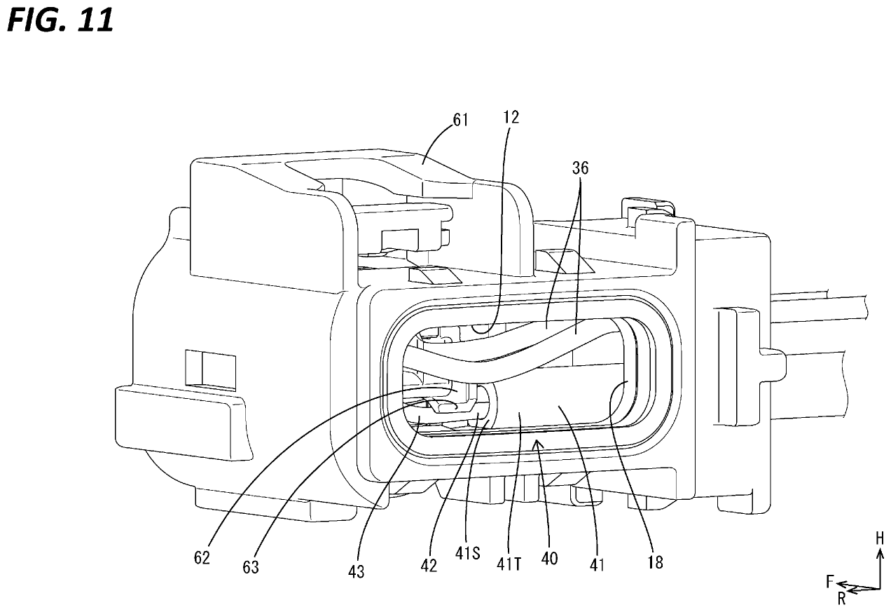

A connector B of a second specific embodiment of the present disclosure is described with reference to FIGS. 9 to 17. In the second embodiment, a direction F in FIGS. 9 to 11 and 15 to 17 is defined as a forward direction concerning a front-rear direction. A direction H in FIGS. 9 to 17 is defined as an upward direction concerning a vertical direction. A direction R in FIGS. 9 to 14 and 17 is defined as a rightward direction concerning a lateral direction. The connector B of the second embodiment differs from the first embodiment in the configuration of a housing body 61 constituting a housing 60. Since the other components are the same as in the first embodiment, the same components are denoted by the same reference signs and the structures, functions and effects thereof are not described.

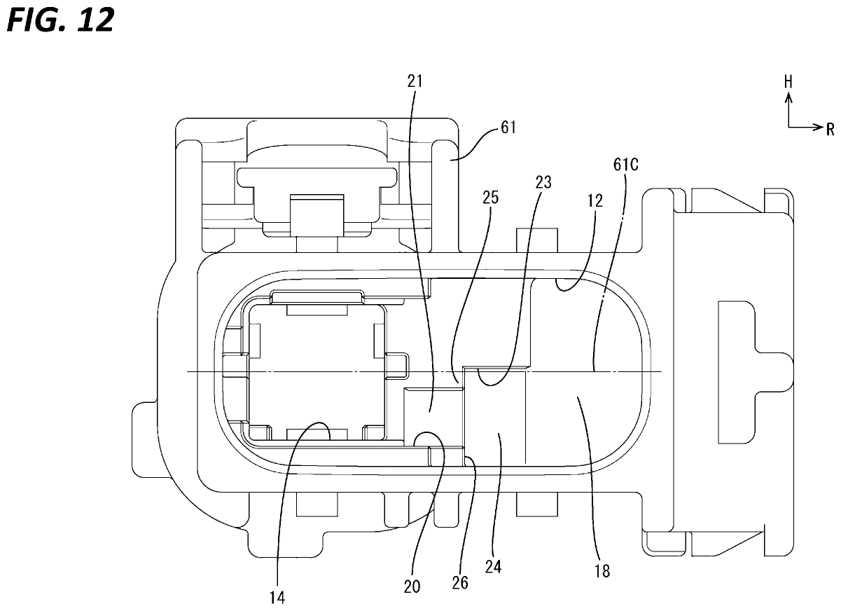

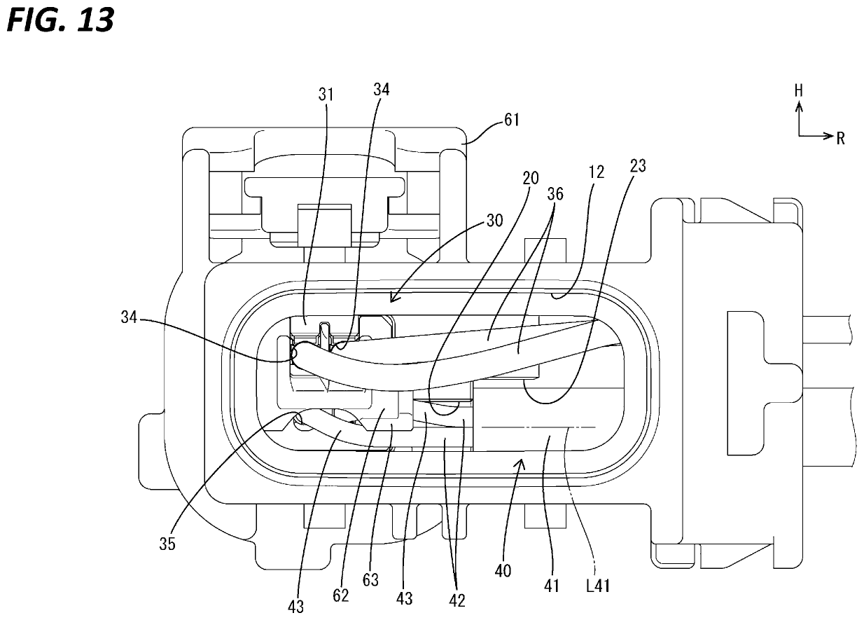

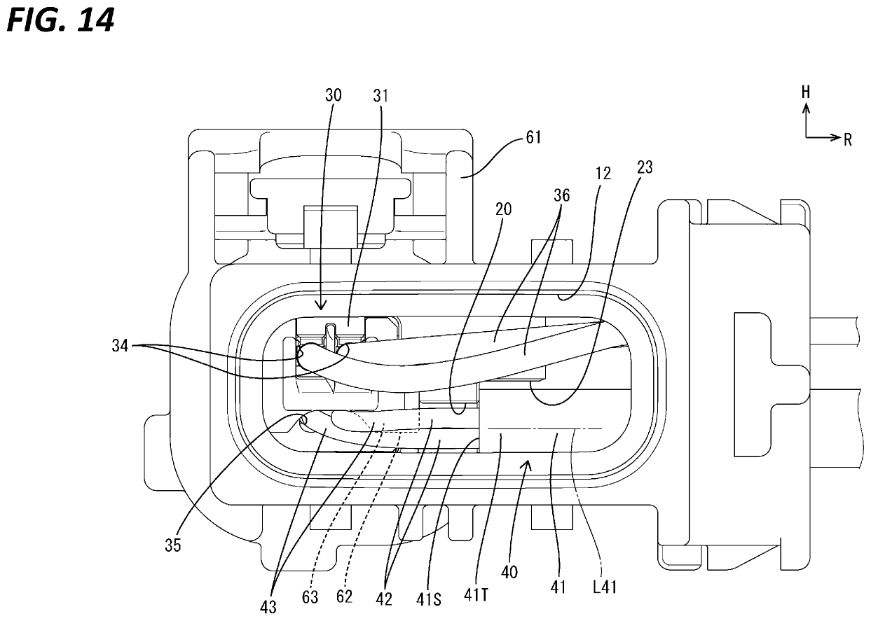

The housing body 61 includes an opening 12 open in the rear surface of the housing body 61, a module accommodation chamber 14, a routing space 18 and a routing hole (not shown). As shown in FIG. 12, the module accommodation chamber 14 is arranged in a left end part of the housing body 61. As shown in FIGS. 13 and 14, a terminal module 30 is inserted into the module accommodation chamber 14 from behind. The routing hole is arranged in a right end part of the housing body 61. Out of the housing body 61, a space from behind the module accommodation chamber 14 to the routing hole functions as the routing space 18. One communication cable 40 and a pair of power wires 36 are routed in the lateral direction in the routing space 18. In the second embodiment, the vertical direction (height direction) orthogonal to a routing direction of the communication cable 40 and the power wires 36 in a back view of the housing body 61 is defined as a width direction.

With the terminal module 30 accommodated in the module accommodation chamber 14, a pair of power supply wire draw-out openings 34 are arranged side by side in the lateral direction in a region above a widthwise center (center in the height direction) in the width direction in the rear surface of a dielectric 31. A pair of signal wire draw-out openings 35 are arranged side by side in the lateral direction in a region below the widthwise center height in the width direction in the rear surface of the dielectric 31. The pair of power wires 36 are routed in a region shifted upward in the width direction from a widthwise center 61C of the housing body 61, out of the routing space 18. The communication cable 40 is routed in a region shifted downward in the width direction from the widthwise center 61C of the housing body 61, out of the routing space 18.

A tip part 41T of a sheath 41 is accommodated into an accommodation recess 23 and positioned in the vertical direction with a tip surface 41S facing leftward. The width direction is a direction orthogonal to an axis L41 of the tip part 41T of the sheath 41 in the accommodation recess 23 in the back view. A routing groove 20, the accommodation recess 23 and the communication cable 40 are arranged at positions deviated downward in the width direction from the widthwise center 61C of the housing body 61. A step portion 25 is formed on a boundary between the left end of the accommodation recess 23 and the right end of the routing groove 20. The step portion 25 is formed with a stopper 26 for restricting the tip part 41T of the sheath 41 from being shifted leftward by being brought into contact with the tip surface 41S of the sheath 41.

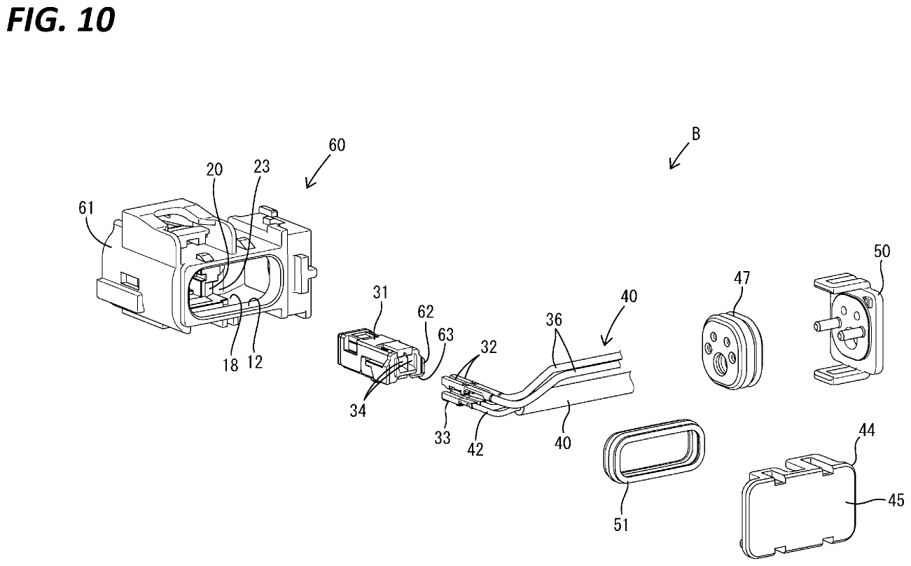

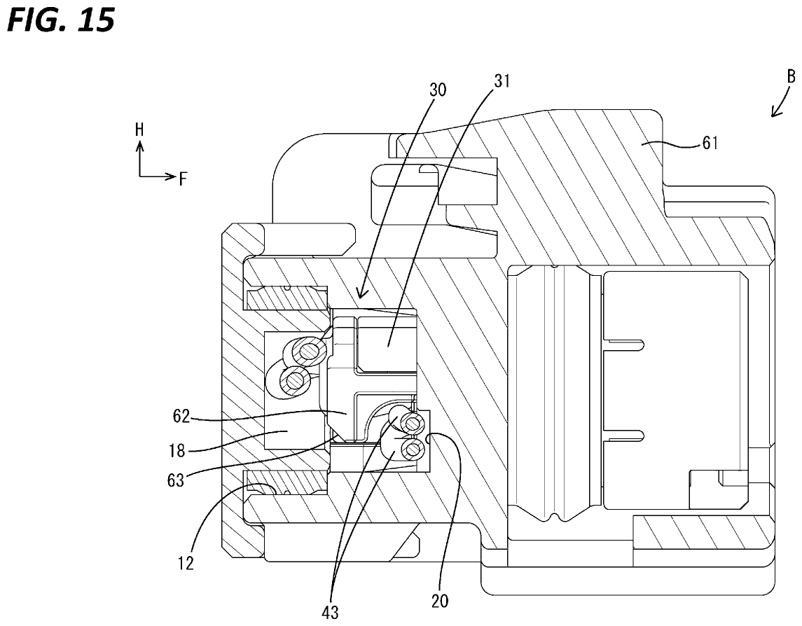

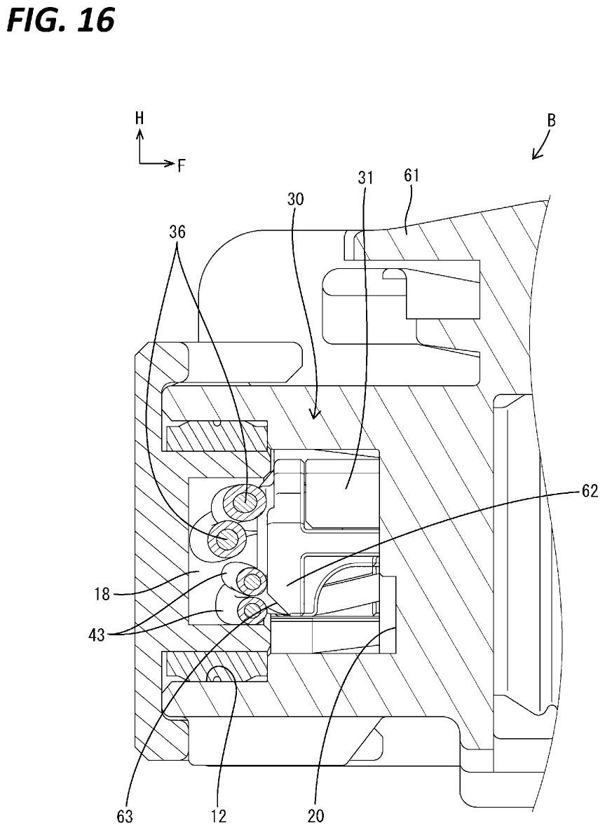

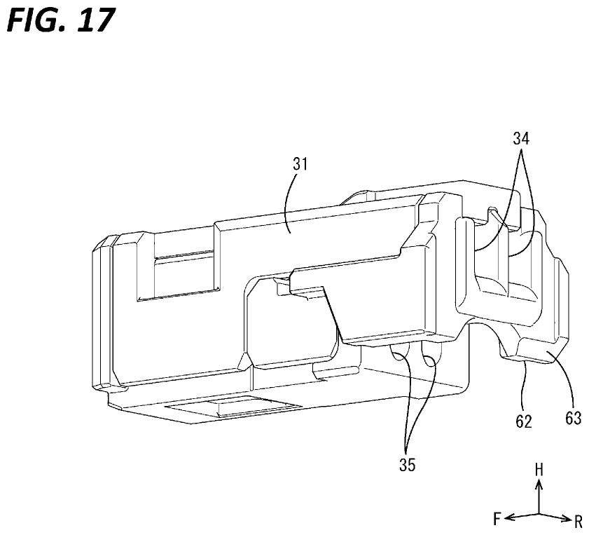

As shown in FIGS. 10 and 17, an eaves portion 62 cantilevered downward is formed in a rear end part of the dielectric 31. As shown in FIGS. 13 and 14, the eaves portion 62 is arranged between the signal wire draw-out openings 35 and the routing groove 20 in the lateral direction. As shown in FIGS. 15 and 17, the eaves portion 62 is located behind routing paths for wire exposed portions 43 between the signal wire draw-out openings 35 and the routing groove 20 in the front-rear direction. The lower end (projecting end) of the eaves portion 62 extends to the same position as a widthwise central part of the routing groove 20 in the width direction (vertical direction). As shown in FIGS. 15 and 16, an overhanging guiding surface 63 inclined forward toward a lower side is formed on the rear surface of the eaves portion 62. The guiding surface 63 is inclined to approach the routing paths for the wire exposed portions 43 toward the projecting end (lower end) of the eaves portion 62.

Next, an assembly procedure of the connector B is described. After the terminal module 30 is inserted into the module accommodation chamber 14 in a procedure similar to that of the first embodiment, the two power wires 36 are routed in an upper region in the routing space 18 and the communication cable 40 is routed in a lower region in the routing space 18. In routing the communication cable 40, the tip part 41T of the sheath 41 is accommodated into the accommodation recess 23 and the two wire exposed portions 43 are accommodated into the routing groove 20.

The eaves portion 62 of the dielectric 31 protrudes to a position behind the routing paths for the wire exposed portions 43 between the signal wire draw-out openings 35 and the routing groove 20. Thus, there is a concern that the wire exposed portion 43 of one signal wire 42 rides on the rear surface of the eaves portion 62 as shown in FIGS. 14 and 16 when an attempt is made to push the tip part 41T (left end part) of the sheath 41 into the accommodation recess 23 from behind.

However, since the guiding surface 63 is formed on the rear surface of the eaves portion 62, the wire exposed portion 43 having ridden on the eaves portion 62 moves obliquely to a lower front side while sliding in contact with the guiding surface 63 if an attempt is made to push the sheath 41 forward toward the accommodation recess 23. The wire exposed portions 43 having passed through the projecting end (lower end) of the eaves portion 62 are stored into the predetermined routing paths and accommodated into the routing groove 20. Since the eaves portion 62 is arranged to closely cover the wire exposed portions 43 from behind in this state, there is no possibility that the wire exposed portions 43 are shifted rearward and separated from the routing groove 20. In the above way, the pair of wire exposed portions 43 are routed in the lateral direction along the axis of the tip part 41T of the sheath 41.

After the power wires 36 and the communication cable 40 are routed in the routing space 18, a one-piece rubber plug 47 is moved leftward and mounted into the routing hole with the power wires 36 and the communication cable 40 held not to move leftward with respect to the housing body 61. Thereafter, a rubber plug holding member 50 is mounted on a right end part of the housing body 61. Even if the communication cable 40 is pushed leftward when the one-piece rubber plug 47 is moved leftward, the communication cable 40 does not move leftward in the routing space 18 since the tip surface 41S of the sheath 41 butts against the stopper 26.

Thereafter, the cover 44 having a rear sealing member 51 mounted therein is mounted on a rear surface part of the housing body 61. In this way, the opening 12 in the rear surface of the housing body 61 is closed in a liquid-tight manner by a plate-like body portion 45 of the cover 44 and the rear sealing member 51. In the above way, the assembly of the connector B is completed.

With the cover 44 mounted on the housing body 61, a separation restricting portion 46 (not shown) of the cover 44 is in contact with or closely facing the tip part 41T of the sheath 41 from behind. In this way, a rearward movement of the communication cable 40 is restricted, wherefore the sheath 41 is held accommodated in the accommodation recess 23 and the wire exposed portions 43 are held accommodated in the routing groove 20.

According to the connector B of the second embodiment, since the separation of the wire exposed portions 43 from each other can be suppressed by accommodating the pair of signal wires 42 (wire exposed portions 43) into the routing groove 20, the degradation of communication characteristics due to an enlarged interval between the wire exposed portions 43 can be suppressed.

The routing groove 20 is shaped to be open rearwardly of the housing 60. The dielectric 31 is formed with the eaves portion 61 having a cantilever shape and covering parts of the routing paths for the wire exposed portions 43 from behind. The rear surface of the eaves portion 62 is formed with the guiding surface 63 for causing the wire exposed portions 43 to slide toward the projecting end of the eaves portion 62 when being pushed from behind by the wire exposed portions 43. According to this configuration, even if the wire exposed portions 43 overlap the rear surface of the eaves portion 62 when the sheath 41 of the communication cable 40 is accommodated into the accommodation recess 23 of the housing body 61, the wire exposed portions 43 can be guided into the routing paths for the wire exposed portions 43 by the guiding surface 63, wherefore the wire exposed portions 43 can be accommodated into the routing groove 20.

The housing 60 is formed with the accommodation recess 23 for accommodating the tip part 41T of the sheath 41. In the back view, the routing groove 20 and the pair of signal wire draw-out openings 35 are arranged side by side in the lateral direction along the axis of the tip part 41T of the sheath 41 accommodated in the accommodation recess 23. According to this configuration, the pair of wire exposed portions 43 can be routed in shortest paths (linear paths) connecting the signal wire draw-out openings 35 and the tip surface 41S of the sheath 41. Further, a routine space in the width direction for the pair of wire exposed portions 43 can be suppressed to be small.

The power wires 36 (other wires) different from the signal wires 42 (wire exposed portions 43) are drawn out from the dielectric 31. The width direction defined in the second embodiment is a direction orthogonal to the axis of the tip part 41T of the sheath 41 accommodated in the accommodation recess 23 in the back view. The signal wire draw-out openings 35 for the signal wires 42 and the power supply wire draw-out openings 34 (other wire draw-out openings) for the power wires 36 are arranged side by side in the width direction. The accommodation recess 23 and the routing groove 20 are arranged at the positions deviated downward in the width direction from the widthwise center 61 of the housing body 61 (housing 60). According to this configuration, the wire exposed portions 43 (signal wires 42) and the power wires 36 can be routed along the paths separated in the width direction. In this way, the degradation of transmission characteristics due to the approach of the power wires 36 and the wire exposed portions 43 (signal wires 42) can be suppressed.

### Other Embodiments

The present invention is not limited to the above described and illustrated embodiments, but is represented by claims. The present invention is intended to include all changes in the scope of claims and in the meaning and scope of equivalents and also include the following embodiments.

In the first and second embodiments, two or more pairs of signal wires may be embedded in the sheath of the communication cable.

In the first embodiment, the housing may not include the guiding portion.

In the second embodiment, the eaves portion may not be formed with the guiding surface.

In the second embodiment, the eaves portion may not be provided.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal module including a communication cable having a pair of signal wires embedded in an insulating sheath, tip regions of the pair of signal wires extending as wire exposed portions from a tip surface of the sheath, and a terminal holding member for accommodating a pair of terminal fittings individually fixed to a pair of the wire exposed portions, the wire exposed portions being drawn out from wire draw-out openings of the terminal holding member; and
a housing for accommodating a tip region of the communication cable and the terminal holding member accommodating the pair of terminal fittings,
a routing groove for accommodating the pair of wire exposed portions being formed in the housing.

2. The connector of claim 1, wherein:
the routing groove is shaped to be open rearwardly of the housing,
the wire draw-out openings are arranged in a widthwise central part of the housing and the routing groove is arranged at a position shifted in the width direction from a widthwise center of the housing in a back view of the housing, and
a guiding portion for guiding the wire exposed portions toward the routing groove when the wire exposed portions are pressed from behind is formed at a position adjacent to the routing groove on the side of the widthwise center.

3. The connector of claim 2, wherein:
the housing is formed with an accommodation recess for accommodating a tip part of the sheath in a positioned state in the back view,
the guiding portion is arranged on a virtual straight line connecting a position of the tip surface of the sheath where the signal wire extends and the wire draw-out opening in the back view with the sheath positioned by the accommodation recess, and
the accommodation recess is arranged forward of the guiding portion.

4. The connector of claim 1, wherein:
the routing groove is shaped to be open rearwardly of the housing,
the terminal holding member is formed with an eaves portion having a cantilever shape, the eaves portion covering parts of routing paths for the wire exposed portions from behind, and
a rear surface of the eaves portion is formed with a guiding surface for causing the wire exposed portions to slide toward a projecting end of the eaves portion when being pushed from behind by the wire exposed portions.

5. The connector of claim 4, wherein:
the housing is formed with an accommodation recess for accommodating a tip part of the sheath, and
the routing groove and a pair of the wire draw-out openings are arranged side by side along an axis of the tip part of the sheath accommodated in the accommodation recess in a back view of the housing.

6. The connector of claim 5, wherein:
another wire different from the signal wires is drawn out from the terminal holding member, and
when a direction orthogonal to the axis of the tip part of the sheath accommodated in the accommodation recess in the back view is defined as a width direction,
the wire draw-out openings for the signal wires and another wire draw-out opening for the other wire are arranged side by side in the width direction, and
the accommodation recess and the routing groove are arranged at positions deviated in the width direction from a widthwise center of the housing.
